(19) United States
(12) Patent Application Publication
(10) Pub. No.: US 2004/0241273 A1
(43) Pub. Date: Dec. 2, 2004

(54) Form tool comprising a membrane and used to produce a component

(76) Inventors: Andreas Hermann, Gartringen (DE); Karl-Heinz Ilzhofer, Kirchheim (DE); Thomas Schuh, Waiblingen (DE); Thorsten Wesse, Gaufelden (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/481,273

(22) PCT Filed: Apr. 9, 2002
(86) PCT No.: PCT/EP02/03910

(30) Foreign Application Priority Data
Jun. 19, 2001 (DE) 10129223.6

(51) Int. Cl. B29C 51/00

(52) U.S. Cl. 425/389

(57) ABSTRACT

A mold for producing components, in particular plastic components, has at least two mold punches, which in a closed position form a mold cavity having the contours of the component At least one mold punch has at least one diaphragm which, by the action of pressure, reduces a volume of the mold cavity.

### BACKGROUND OF THE INVENTION

The invention relates to a mold for producing plastic components comprising at least two mold punches which, in a closed position, form a mold cavity having the contours of the plastic component.

Molds for producing plastic components, in particular from fiber-reinforced sheet molding compounds (SMC materials), are generally configured as what are known as positive molds.

Positive molds comprise two mold punches, also referred to below as compression punches, with vertical outside edges, with one punch moving over the other punch in the manner of a sleeve. By way of example, an SMC semi-finished product is placed into a mold cavity formed by the compression punches. The SMC semi-finished product comprises a defined weight of raw material, which generally includes resins, hardeners, fillers and fibers (in particular glass fibers) and is built up in layers of rectangular mats. The compression punches then move over one another and compress the semi-finished product in such a way that it fills the mold cavity. The compression punches are heatable, so that the hardener cures the resin of the component.

EP 0 064 247 A1 describes an injection mold which is suitable for the production of spectacle lenses, wherein, after the injection-molding operation, a thermoplastic material is shaped into an aspherical surface by means of an elastically deformable surface of the mold.

Molds of this type are very complex to produce on account of their tight tolerances and are therefore also very expensive. However, positive molds are required to produce plastic components because the metering of raw materials by weight cannot generally be achieved with the desired level of accuracy which would be required for the use of what are known as pinch-edge molds.

Pinch-edge molds are designed in such a manner that the compression punches bear flat against one another in the closed position. However, this means that in the closed position there is no play for a follow-up pressure on the semi-finished product. If the semi-finished product contains too little raw material, the component is not formed correctly, and this manifests itself in inadequate materials properties. If there is too much raw material in the mold cavity, this material is pressed between the compression punches, which prevents the punches from being completely closed.

### SUMMARY OF THE INVENTION

An object of the present invention is to provide a mold of the type described above with reduced tooling costs which makes it possible to compensate for fluctuations in the raw-material volume and shrinkage which occurs during component production.

The foregoing object has been achieved by a mold having at least one mold punch with at least one diaphragm which, by pressure action, reduces the volume of the mold cavity.

The mold according to the invention includes at least two compression punches. In a closed state, these compression punches form a mold cavity which forms the contours of a component which is to be produced.

At least one compression punch is provided with a diaphragm according to the present invention. The diaphragm moves inward with respect to the mold cavity under the action of pressure and thereby reduces the volume of the mold cavity. In this way, it is possible to exert additional pressure on the raw material and to compensate for fluctuations in the volume of the raw material and shrinkage of the raw material during shaping.

The diaphragm according to the invention particularly preferably acts on pinch-edge tools, the compression punches of which bear flat against one another in the closed position. Molds of this type are favorable in terms of production, which means that the process costs required to produce SMC components are considerably reduced.

The diaphragm preferably consists of a metal which has a high strength, a high thermal stability and a high ductility. Metal sheets made from high-strength steels or superplastic alloys (memory metals) are particularly suitable. The thickness of the diaphragm is usually between 0.5 mm and 5 mm.

The diaphragm is preferably welded to the compression punch. This makes it impossible for any raw material to escape from the mold cavity. Some advantageous diaphragm materials, such as superplastic alloys, are more suitable for attachment using screws or similar attachment mechanisms. In this case, however, an additional seal, for example formed by neoprene, rubber or silicone, is expedient.

An advantageous way of producing the pressure on the diaphragm consists in applying a hydraulic pressure or a gas pressure which is transmitted by a pressure medium (e.g., hydraulic fluid or air). The pressure is preferably produced in a cavity in the compression punch, in front of the diaphragm with respect to the mold cavity. The pressure is generated by a hydraulic pump or by compressed air or other gases.

It is expedient for the pressure medium to be stored in a flexible container which is in direct contact with the diaphragm. A build-up of pressure in this container at the same time moves the diaphragm. This arrangement prevents the pressure medium—if the diaphragm is screwed to the compression punch—from entering the mold cavity. The demand imposed on the compression punch, which is often composed of a plurality of components, with regard to the sealing properties with respect to the pressure media is thereby likewise reduced. This contributes to a drop in cooling costs.

A further advantageous generation of the pressure on the diaphragm is effected by way of a piston. The piston is arranged in the compression punch and presses directly on the diaphragm. The temperature of the piston, like that of the abovementioned flexible container and the diaphragm, can be controlled, and can in this way be matched to the temperature of the compression punch.

The diaphragm according to the present invention can be used with virtually all types of molds. It is expedient for all molds in which volumetric shrinkage of the component material takes place during component production. This applies to compression molds or injection molds for plastics processing, and to casting molds or Thixomolding or Thixocasting molds for processing light metals, such as magnesium or aluminum.

### BRIEF DESCRIPTION OF THE DRAWINGS

These and other objects, features and advantages of the present invention will become more readily apparent from the following detailed description of currently preferred configurations thereof when taken in conjunction with the accompanying drawings wherein:

FIG. 1 is a cross-sectional elevational view of a compression mold having a diaphragm and a hydraulic device for moving the diaphragm, in the open position,

FIG. 2 is a view of the compression mold as shown in FIG. 1, but in the closed position,

FIG. 3 is a cross-sectional elevational view of a compression mold having a flexible container for application of a hydraulic pressure to a diaphragm, and

FIG. 4 is a cross-sectional elevational view of a compression mold having a piston for application of a pressure to a diaphragm.

### DETAILED DESCRIPTION OF THE DRAWINGS

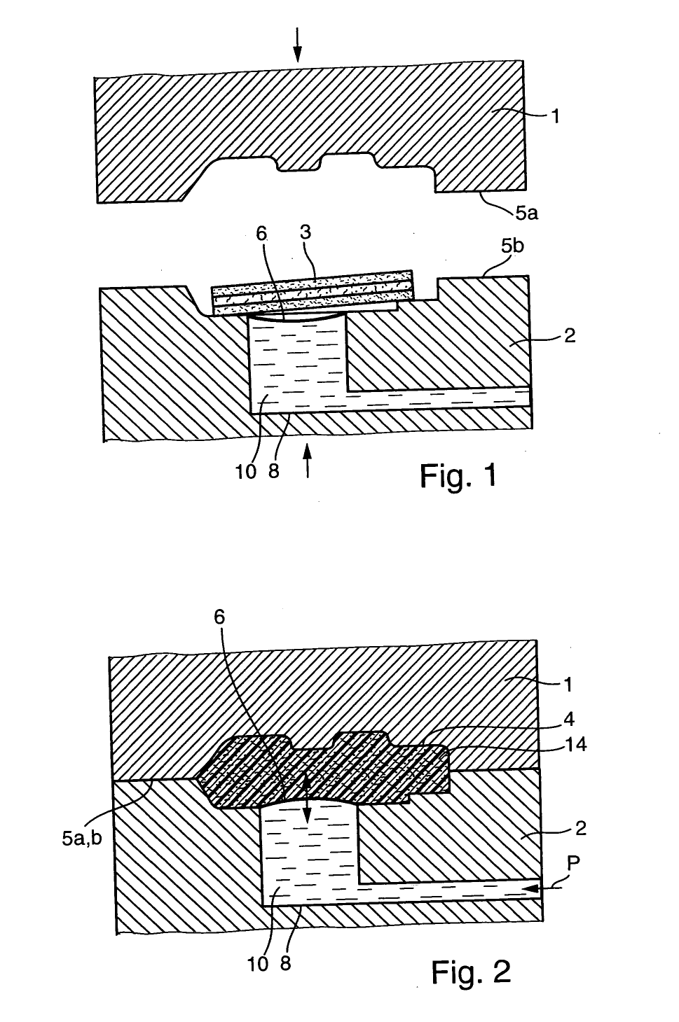

FIG. 1 illustrates a compression mold which comprises an upper compression punch 1 and a lower compression punch 2. The lower compression punch 2 includes a diaphragm 6 which adjoins a cavity 8 and consists of elastic steel sheet (thickness 1 mm). The cavity 8 is filled with a hydraulic fluid 10.

An SMC semi-finished product 3, which is composed of a plurality of layers of SMC raw material (comprising resin, binder and fillers), is placed in the lower compression punch 2.

The upper punch 1 and the lower punch 2 in the closed position (FIG. 2) form a mold cavity 4. The mold cavity 4 is vertically surrounded by the parting surfaces 5a and 5b of the respective punches 1 and 2, which in the closed position form the parting plane 5.

The volume of the SMC semi-finished product 3 is designed in such a way that in the closed position it virtually fills the mold cavity 4. Because it is not possible for the volume of the SMC semi-finished product 3 and of the mold cavity 4 to be made completely identical under acceptable conditions when producing the SMC semi-finished product 3, according to the present invention the volume compensation and the build-up of pressure are effected by the diaphragm 6.

The hydraulic fluid 10 in the cavity 8 in front of the diaphragm 6 is placed under pressure by a known hydraulic pump (not shown). Under the action of pressure, the diaphragm 6 moves approx. 0.3 mm toward the mold cavity 4. This movement is sufficient to apply the pressure required for component shaping in the mold cavity.

During the compression operation, the temperature of the compression mold and the hydraulic fluid 10 is controlled to approximately 140° C. This temperature produces a curing reaction between a hardener and a resin in the semi-finished product 3. After the curing operation, a SMC component 14 is demolded from the compression mold.

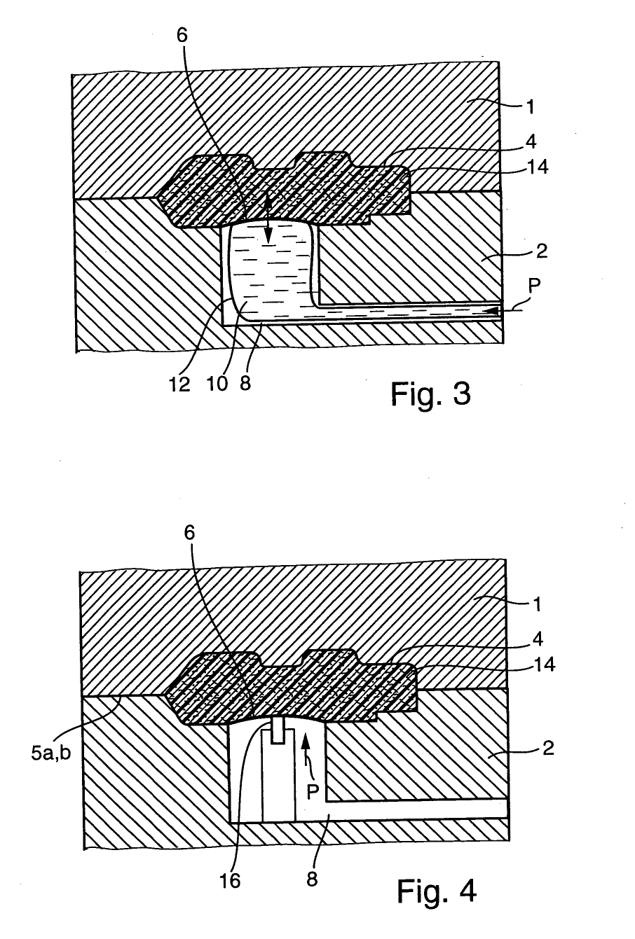

The compression mold shown in FIG. 3 is of similar structure to that shown in FIG. 2, the difference being that the cavity 8 in front of the diaphragm contains a rubber container 12 in which hydraulic fluid 10 is once again located. The diaphragm 6 is secured to the lower punch 2 by a screw connection (not shown in more detail). Pressure is applied to the rubber container 12 via a hydraulic pump and in this arrangement then acts on the diaphragm. The advantage of this arrangement is that the hydraulic fluid 10 is inside the closed container 12 and therefore cannot penetrate into the mold cavity 4. There is no need for a complex sealing arrangement for the diaphragm between the mold cavity 4 and the cavity 8.

A further advantageous configuration of a compression mold in accordance with the present invention is shown in FIG. 4 which is of similar structure to the compression molds shown in FIGS. 1 to 3, except that the cavity 8 contains a piston 16 instead of a pressurized medium. The diaphragm 6 is welded to the lower punch 2. The piston 16 presses on the diaphragm 6, with the result that the latter moves toward the mold cavity 4 and transmits the pressure to the SMC raw material. This arrangement prevents the piston 16 from being soiled by the raw material in the mold cavity 4, because the diaphragm 6 represents a sealed barrier. Therefore, the functioning of the piston 16 is not impaired. The piston 16 can be heated if necessary for optimal functioning.

Although the present invention has been illustrated and described with respect to exemplary embodiment thereof, it should be understood by those skilled in the art that the foregoing and various other changes, omission and additions may be made therein and thereto, without departing from the spirit and scope of the present invention. Therefore, the present invention should not be understood as limited to the specific embodiment set out above but to include all possible embodiments which can be embodied within a scope encompassed and equivalent thereof with respect to the feature set out in the appended claims.

1-6. (Cancelled)

7. A mold for producing a plastic component, comprising at least two mold punches, which, in a closed position, are configured to form a mold cavity having contours of the plastic component, at least one of the mold punches having at least one diaphragm which, by the action of pressure, reduces the volume of the mold cavity, wherein the mold is configured as a temperature-controllable compression mold such that regions of any of the mold punches which do not include the mold cavity bear flat against one another, and the mold cavity being configured to position an SMC semi-finished product comprising resin, hardener, fillers and fibers therein, such that the SMC semi-finished product virtually fills the mold cavity in the closed position, and the diaphragm being operative to effect volume compensation between the mold cavity and the SMC semi-finished product, whereby the SMC semi-finished product is cured with temperature control of the mold.

8. The mold as claimed in claim 7, wherein the at least one diaphragm is a metal diaphragm.

9. The mold as claimed in claim 7, wherein the at least one diaphragm is welded or screwed into the mold cavity.

10. The mold as claimed in claim 9, wherein the at least one diaphragm is a metal diaphragm.

11. The mold as claimed in claim 7, wherein one of gas or hydraulic pressure is provided for external pressure action on the at least one diaphragm.

12. The mold as claimed in claim 11, wherein the at least one diaphragm is a metal diaphragm.

13. The mold as claimed in claim 12, wherein the at least one diaphragm is welded or screwed into the mold cavity.

14. The mold as claimed in claim 11, wherein a pressure medium supplying the gas or hydraulic pressure is enclosed in a flexible container.

15. The mold as claimed in claim 7, wherein a piston is provided for external pressure action on the at least one diaphragm.

16. The mold as claimed in claim 15, wherein the at least one diaphragm is a metal diaphragm.

17. The mold as claimed in claim 16, wherein the at least one diaphragm is welded or screwed into the mold cavity.

18. A process for producing a plastic component in a compression mold having at least two mold punches which, in a closed position, form a mold cavity having contours of the plastic component and configured such that regions of the mold punches which do not include the mold cavity bear flat against one another, and at least one mold punch with at least one diaphragm which, using pressure, reduces volume of the mold cavity, comprising positioning an SMC semi-finished product comprising resin, hardener, fillers and fibers in the mold cavity; substantially filling the mold cavity with the SMC semi-finished product in the closed position; providing volume compensation between the mold cavity and the SMC semi-finished product via the diaphragm; and controlling mold temperature to cure the SMC semi-finished product.

19. The process as claimed in claim 18, wherein external pressure action on the diaphragm is effected by gas pressure or hydraulic pressure.

20. The process as claimed in claim 18, wherein external pressure action on the diaphragm is effected by a piston.
